(19) United States
(12) Patent Application Publication
(10) Pub. No.: US 2026/0332686 A1
(43) Pub. Date: Oct. 22, 2026

(54) DEVICES, METHODS, APPARATUSES AND COMPUTER READABLE MEDIUM FOR COMMUNICATIONS

(71) Applicant: Nokia Technologies Oy, Espoo (FI)

(72) Inventors: Yonggang WANG, Shanghai (CN); Chunli WU, Beijing (CN); Benoist Pierre SEBIRE, Tokyo (JP); Hua CHAO, Shanghai (CN)

(21) Appl. No.: 19/116,906

(22) PCT Filed: Sep. 30, 2022
(86) PCT No.: PCT/CN2022/123121

§ 371 Date: Mar. 28, 2025

(51) Int. Cl. H04L 69/322; H04W 28/02

(52) U.S. Cl. CPC H04L 69/322; H04W 28/0278

(57) ABSTRACT

Embodiments of the present disclosure disclose devices, methods and apparatuses for a beam reporting. A terminal device receives a configuration of mapping restriction for performing a logical channel prioritization (LCP) procedure associated with a configured grant (CG) from a network device. The mapping restriction is configured for a medium access control (MAC) control element (CE). The terminal device performs the LCP procedure to generate a MAC Protocol Data Unit (PDU) for the CG based on the mapping restriction. Then, the terminal device transmits the MAC PDU to the network device via the CG.

### FIELD

Embodiments of the present disclosure generally relate to the field of communication, and in particular, to devices, methods, apparatuses and computer readable storage medium for communications.

### BACKGROUND

With the development of communication technology, a terminal device is able to report to a network device with status information on data to be transmitted. In general, the status information may include the amount of data, traffic type of the data, Quality of Service (QoS) required by the data, and so on. As such, the network device may schedule communication resources for the terminal device accordingly. In some cases, the status information on data to be transmitted may be included in a Buffer Status Report (BSR). The terminal device then may transmit a medium access control (MAC) control unit (CE) for the BSR to the network device.

In addition, it has been agreed to prioritize the traffic data transmission that is buffered in certain logic channels among a plurality of logic channels, in order to achieve a performance trade-off for a plurality of traffic that each has different characteristics. Prioritizing the traffic data transmission in certain logic channels may be also referred to be a Logical Channel Prioritization (LCP) procedure. Further, the prioritization of the MAC CE may be also a key aspect.

### SUMMARY

In general, example embodiments of the present disclosure provide devices, methods, apparatuses and computer readable storage medium for beam reporting.

In a first aspect, there is provided a terminal device. The terminal device may comprise at least one processor; and at least one memory storing instructions that, when executed by the at least one processor, cause the terminal device to: receive, from a network device, a configuration of mapping restriction for performing a logical channel prioritization (LCP) procedure associated with a configured grant (CG). The mapping restriction is configured for a medium access control (MAC) control element (CE). The terminal device is further caused to perform the LCP procedure to generate a MAC Protocol Data Unit (PDU) for the CG based on the mapping restriction; and transmit the MAC PDU to the network device via the CG.

In a second aspect, there is provided a network device. The network device may comprise at least one processor; and at least one memory storing instructions that, when executed by the at least one processor, cause the network device to: transmit, to a terminal device, a configuration of mapping restriction for performing a logical channel prioritization (LCP) procedure associated with a configured grant (CG). The mapping restriction is configured for a medium access control (MAC) control element (CE). The network device is further caused to receive a MAC PDU from the terminal device via the CG.

In a third aspect, there is provided a method implemented at a terminal device. The method comprises: receiving, from a network device, a configuration of mapping restriction for performing a logical channel prioritization (LCP) procedure associated with a configured grant (CG). The mapping restriction is configured for a medium access control (MAC) control element (CE). The method further comprises performing the LCP procedure to generate a MAC PDU for the CG based on the mapping restriction; and transmitting the MAC PDU to the network device via the CG.

In a fourth aspect, there is provided a method implemented at a network device. The method comprises: transmitting, to a terminal device, a configuration of mapping restriction for performing a logical channel prioritization (LCP) procedure associated with a configured grant (CG), the mapping restriction being configured for a medium access control (MAC) control element (CE); and receiving a MAC PDU from the terminal device via the CG.

In a fifth aspect, there is provided an apparatus of a terminal device. The apparatus comprises: means for receiving, from a network device, a configuration of mapping restriction for performing a logical channel prioritization (LCP) procedure associated with a configured grant (CG), the mapping restriction being configured for a medium access control (MAC) control element (CE); means for performing the LCP procedure to generate a MAC PDU for the CG based on the mapping restriction; and means for transmitting the MAC PDU to the network device via the CG.

In a sixth aspect, there is provided an apparatus of a network device. The apparatus comprises: means for transmitting, to a terminal device, a configuration of mapping restriction for performing a logical channel prioritization (LCP) procedure associated with a configured grant (CG), the mapping restriction being configured for a medium access control (MAC) control element (CE); and means for receiving a MAC PDU from the terminal device via the CG.

In an seventh aspect, there is provided a non-transitory computer readable medium comprising program instructions for causing an apparatus to perform at least the method according to any of third to fourth aspects.

In an eighth aspect, there is provided a computer program comprising instructions, which, when executed by an apparatus, cause the apparatus at least to: receive, from a network device, a configuration of mapping restriction for performing a logical channel prioritization (LCP) procedure associated with a configured grant (CG). The mapping restriction is configured for a medium access control (MAC) control element (CE). The terminal device is further caused to perform the LCP procedure to generate a MAC PDU for the CG based on the mapping restriction; and transmit the MAC PDU to the network device via the CG.

In an ninth aspect, there is provided a computer program comprising instructions, which, when executed by an apparatus, cause the apparatus at least to: transmit, to a terminal device, a configuration of mapping restriction for performing a logical channel prioritization (LCP) procedure associated with a configured grant (CG). The mapping restriction is configured for a medium access control (MAC) control element (CE). The network device is further caused to receive a MAC PDU from the terminal device via the CG.

In a tenth aspect, there is provided a terminal device. The terminal device comprises receiving circuitry configured to: receive, from a network device, a configuration of mapping restriction for performing a logical channel prioritization (LCP) procedure associated with a configured grant (CG); a performing circuitry configured to perform the LCP procedure the LCP procedure to generate a MAC PDU for the CG based on the mapping restriction; and a transmitting circuitry configured to transmit the MAC PDU to the network device via the CG.

In a eleventh aspect, there is provided a network device. The network device comprises transmitting circuitry configured to transmit, to a terminal device, a configuration of mapping restriction for performing a logical channel prioritization (LCP) procedure associated with a configured grant (CG). The mapping restriction is configured for a medium access control (MAC) control element (CE); and receiving circuitry configured to receive the MAC PDU from the terminal device via the CG.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example network environment in which example embodiments of the present disclosure may be implemented;

FIG. 1B illustrates examples of data traffic and corresponding QoS information according to some embodiments of the present disclosure;

FIGS. 1C to 1E are examples of the BSR report according to some embodiments of the present disclosure;

FIG. 2 illustrates an example signaling process for applying the configuration of mapping restriction on the MAC CE according to some embodiments of the present disclosure;

FIG. 3 illustrates an example of the BSR report by applying a configuration of mapping restriction for CG according to some embodiments of the present disclosure;

FIG. 4 illustrates flowchart of a method implemented at a terminal device according to example embodiments of the present disclosure;

FIG. 5 illustrates an example flowchart of a method implemented at a network device according to example embodiments of the present disclosure;

FIG. 6 illustrates an example simplified block diagram of an apparatus that is suitable for implementing embodiments of the present disclosure; and

FIG. 7 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, the prioritization restriction is not applied to the transmission of MAC CE yet. In some cases, the terminal device may desire to transmit the MAC CE for the BSR whenever the data of traffic arrived, in order to inform the network device with the information on data to be transmitted timely. In general, it may hardly transmit the BSR in this ideal manner. Because in some situations, a timer for triggering the transmission of the MAC CE for BSR may be restarted, and the alignment between the arriving time of the data of traffic and the configured grant (CG) is affected accordingly.

At least for solving the above issues and improving the performance of a communication system, there is providing a scheme for applying prioritization restriction to the MAC CE. In this scheme, a terminal device receives a configuration of mapping restriction for performing a logical channel prioritization (LCP) procedure associated with a configured grant (CG) from a terminal device. The mapping restriction is configured for a medium access control (MAC) control element (CE). The terminal device 110 performs the LCP procedure to generate a MAC PDU for the CG based on the mapping restriction. Then, the terminal device transmits the MAC PDU to the network device via the CG.

In this way, the terminal device is able to transmit the MAC CE for the BSR in the CG that is associated with the mapping restriction, and therefore the MAC CE for the BSR can be transmitted timely by appropriately configuring the CG. It is to be understood that although the embodiments in this disclosure is always discussed with reference to the MAC CE for BSR, the solutions proposed by this disclosure may be also applied to the MAC CE for other purposes without any limitation.

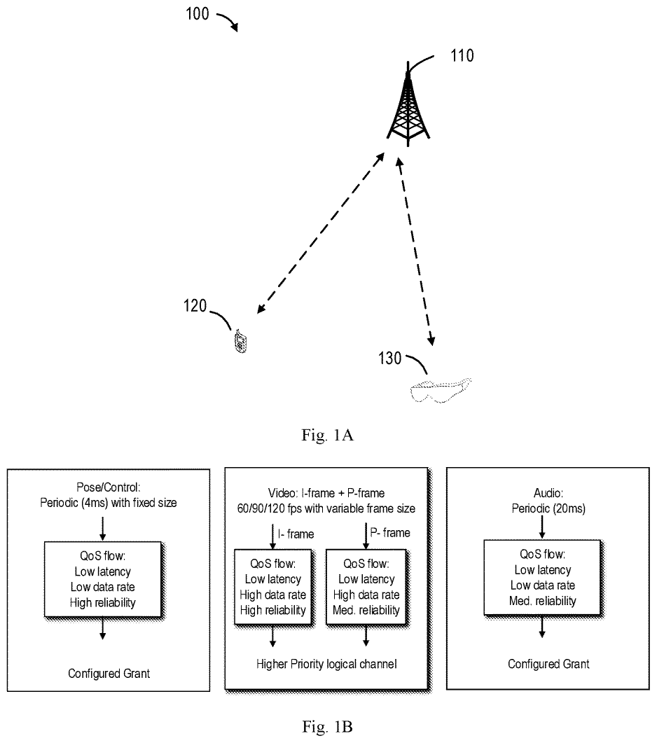

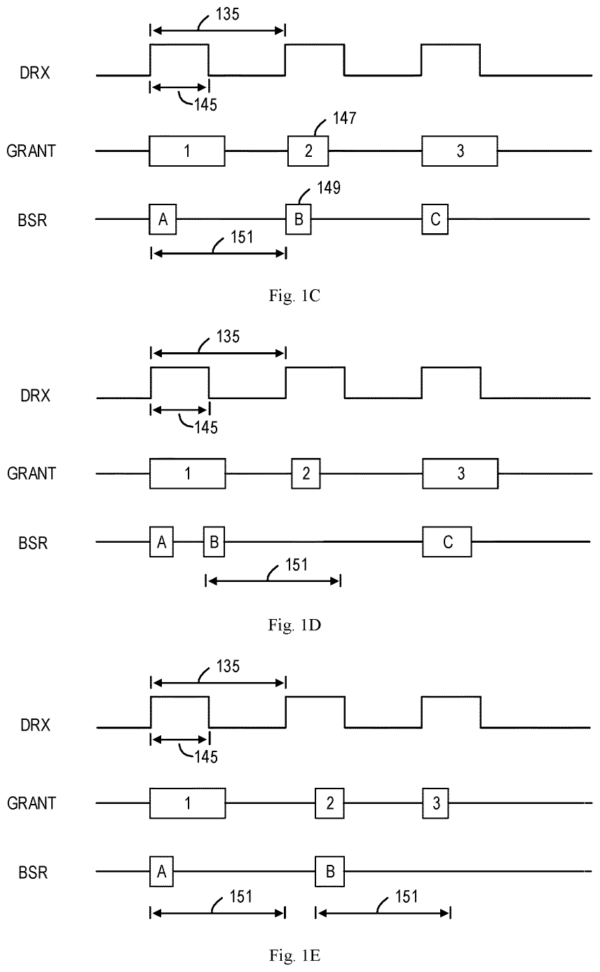

Principle and embodiments of the present disclosure will be described in detail below with reference to the accompanying drawings. FIG. 1A illustrates an example network environment 100 in which example embodiments of the present disclosure may be implemented. The environment 100, which may be a part of a communication network, includes terminal devices and network devices.

As illustrated in FIG. 1, the network environment 100 may include a network device 110, terminal devices 120 and 130. The terminal devices as shown in FIG. 1A may be any terminal device as mentioned above or an electronic device for implementing Extended Reality (XR) traffic, for example, Virtual Reality (VR) traffic, Augmented Reality (AR) traffic and Mixed Reality (MR) traffic. In one embodiment, CG may be configured to the terminal device 120 and/or 130 by the network device 110 via a Radio Resource Control (RRC) signaling. Then, the terminal device 120 and/or terminal device 130 may transmit at least one of data of traffic mapped based on the LCP procedure or MAC CEs to the network device via the CG.

It is to be understood that the number of network devices and terminal devices is given only for the purpose of illustration without suggesting any limitations. The system 100 may include any suitable number of network devices and/or terminal devices adapted for implementing embodiments of the present disclosure. Although not shown, it would be appreciated that one or more terminal devices may be located in the environment 100.

Communications in the network environment 100 may be implemented according to any proper communication protocol(s), comprising, but not limited to, the third generation (3G), the fourth generation (4G), the fifth generation (5G) or beyond, wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: multiple-input multiple-output (MIMO), orthogonal frequency division multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), carrier aggregation (CA), dual connection (DC), and new radio unlicensed (NR-U) technologies.

FIG. 1B illustrates examples of data traffic and corresponding QoS information according to some embodiments of the present disclosure.

For illustrative purposes and without any limitation, FIG. 1B shows the example characteristics and requirements of uplink data transmission for XR, for example, characteristics and requirements for uplink data transmission of pose/control traffic, video traffic or audio traffic. For the pose/control traffic, the terminal device may periodically (for example, 4 ms) transmit data having a fixed size via the CG to the network device. Further, the QoS flow for the pose/control traffic is “low latency”, “low data rate” and “high reliability”. For the audio traffic, the terminal device also periodically (for example, 20 ms) transmits data via the CG to the network device. Further, the QoS flow for the audio traffic is “low latency”, “low data rate” and “Medium reliability”. For the video traffic, the terminal device also periodically transmits Intra-frame (I-frame) and Predictive-frame (P-frame) via the CG to the network device, except the data size is variable, for example, 60 fps, 90 fps or 120 fps. Further, the QoS flow for the I-frame is “low latency”, “high data rate” and “High reliability”, and the QoS flow for the P-frame is “low latency”, “high data rate” and “Medium reliability”.

At least for the above video traffic, it may be desirable to transmit or have a BSR report for data of video traffic when the data of video traffic is arrived, since the data of video traffic has variable size. Generally, periodic BSR that aligns with the periodic data of video traffic would be a natural option. However, it is difficult to ensure that the periodic BSR always aligns with the video traffic arrival timing even if the periodicity for the video traffic is fixed. Because in some cases, if there is any available resource in any Uplink (UL) CG, the timer for BSR will be started or restarted every time when a BSR or a padding BSR is included the MAC CE for the BSR. For illustrative purposes, some situations regarding the BSR report is further discussed with reference to FIGS. 1C to 1E.

FIG. 1C illustrates an example of the BSR report ideally transmitted according to some embodiments of the present disclosure.

As shown in FIG. 1C, the first time length 135 represents a Discontinuous Reception (DRX) cycle of a terminal device, the second time length 145 represents the ON DURATION of the DRX cycle and the third time length 151 represents the a periodic of a periodic BSR timer.

In an example, a grant is precisely configured at the beginning of every ON-DURATION and no padding BSR other than truncated BSRs are sent at the end of the CG. In this case, it is possible to align the periodic BSR report with the DRX cycle, for example, the BSR 149 may be triggered in alignment with the CG 147. However, it is hardly to be implemented, as it is not possible to guarantee that only truncated BSRs are sent when a padding BSR is needed. Otherwise, the padding BSR other than the truncated BSR may trigger a restart of the periodic BSR timer, and the restart of the periodic BSR timer may affect the above alignment. For illustrative purposes, the possible situations are further shown in FIGS. 1D to 1E.

In addition, some embodiments regarding the BSR report and the periodic BSR timer are listed below. Specifically, a periodic BSR is triggered when the periodic BSR timer expires and the periodic BSR timer is (re) started whenever a BSR has been triggered and that BSR is not a truncated BSR, i.e., it contains a complete picture of the BSR status.

```
A BSR shall be triggered if any of the following events occur for activated cell group:
  UL data, for a logical channel which belongs to an LCG, becomes available to the
MAC entity; and either
  this UL data belongs to a logical channel with higher priority than the priority of any
logical channel containing available UL data which belong to any LCG; or
  none of the logical channels which belong to an LCG contains any available UL data.
  in which case the BSR is referred below to as ‘Regular BSR’;
  UL resources are allocated and number of padding bits is equal to or larger than the
size of the Buffer Status Report MAC CE plus its subheader, in which case the BSR is
referred below to as ‘Padding BSR’;
  retxBSR-Timer expires, and at least one of the logical channels which belong to an
LCG contains UL data, in which case the BSR is referred below to as ‘Regular BSR’;
  periodicBSR-Timer expires, in which case the BSR is referred below to as ‘Periodic
BSR’.
```

The MAC entity shall:

| 1> | if the Buffer Status reporting procedure determines that at least one BSR has been | |
|---|---|---|
| | triggered and not cancelled: | |
| | 2> | if UL-SCH resources are available for a new transmission and the UL-SCH |
| | | resources can accommodate the BSR MAC CE plus its subheader as a result of |
| | | logical channel prioritization: |

| | |
|---|---|
| 3> | instruct the Multiplexing and Assembly procedure to generate the BSR MAC |
| | CE(s) as defined in clause 6.1.3.1; |

3> start or restart periodicBSR-Timer except when all the generated BSRs are long or short
Truncated or Extended long or short Truncated BSRs;

FIG. 1C illustrates an example of the BSR report according to some embodiments of the present disclosure. As shown in FIG. 1C, because the periodic BSR Timer is started or restarted when a complete BSR or non-truncated BSR (BSR A or BSR B) is sent in the first CG (Grant 1 as shown in FIG. 1D). Therefore, the periodic BSR timer is to be restarted when including the BSR B into the MAC CE at the end of this data burst. As such, the periodic BSR timer is still running when the next CG (Grant 2 as shown in FIG. 1D) arrives, the terminal device cannot transmit the periodic BSR at the second occurrence of the ON-DURATION. In this case, if the video data is buffered at the terminal device periodically during the timer is running, the terminal device cannot transmit the BSR to the network device timely.

FIG. 1D illustrates another example of the BSR report according to some embodiments of the present disclosure. In some cases, it is possible that the network device or scheduler cannot provide grants precisely at the start of every ON-DURATION (due to for instance to temporary overload), this may cause that the periodic BSR timer is started later. In some cases, the periodic BSR timer is started later enough so that the BSR misses the next ON-DURATION. As shown by FIG. 1E, since the Grant 2 is configured late, and the periodic BSR timer is still running when the subsequent Grant 3 is configured. This causes that the terminal device cannot transmit the BSR in the third DRX ON DURATION.

In order to achieve the performance trade-off between data transmissions of a plurality of traffic types, utilizing LCP restrictions to prioritize UL grant with certain characteristics for certain LCH(s). However, there is no such restriction for MAC CEs which means that MAC CEs can be multiplexed into any available UL grant according to MAC CE priority order if there is enough space. However, this may disturb the intended periodicity for BSR when the MAC CE for BSR is included in other UL grant. Specifically, the LCP procedure and the MAC CE order are listed below.

38.321:

| | |
|---|---|
| 5.4.3 | Multiplexing and assembly |
| 5.4.3.1 | Logical Channel Prioritization |
| 5.4.3.1.1 | General |

```
. . .
RRC additionally controls the LCP procedure by configuring mapping restrictions for each
logical channel:
  allowedSCS-List which sets the allowed Subcarrier Spacing(s) for transmission;
  maxPUSCH-Duration which sets the maximum PUSCH duration allowed for
transmission;
  configuredGrantType1Allowed which sets whether a configured grant Type 1 can be
used for transmission;
  allowedServingCells which sets the allowed cell(s) for transmission;
  allowedCG-List which sets the allowed configured grant(s) for transmission;
  allowedPHY-PriorityIndex which sets the allowed PHY priority index(es) of a dynamic
grant for transmission;
  allowedHARQ-mode which sets the allowed uplinkHARQ-mode for transmission.
```

| | |
|---|---|
| 5.4.3.1.3 | Allocation of resources |

```
. . .
Logical channels shall be prioritised in accordance with the following order (highest
priority listed first):
  MAC CE for C-RNTI, or data from UL-CCCH;
  MAC CE for (Enhanced) BFR, or MAC CE for Configured Grant Confirmation, or
MAC CE for Multiple Entry Configured Grant Confirmation;
  MAC CE for Sidelink Configured Grant Confirmation;
  MAC CE for LBT failure;
  MAC CE for Timing Advance Report;
  MAC CE for SL-BSR prioritized according to clause 5.22.1.6;
  MAC CE for (Extended) BSR, with exception of BSR included for padding;
  MAC CE for (Enhanced) Single Entry PHR, or MAC CE for (Enhanced) Multiple
Entry PHR;
  MAC CE for Positioning Measurement Gap Activation/Deactivation Request;
  MAC CE for the number of Desired Guard Symbols;
  MAC CE for Case-6 Timing Request;
  MAC CE for (Extended) Pre-emptive BSR;
  MAC CE for SL-BSR, with exception of SL-BSR prioritized according to clause
5.22.1.6 and SL-BSR included for padding;
  MAC CE for IAB-MT Recommended Beam Indication, or MAC CE for Desired
IAB-MT PSD range, or MAC CE for Desired DL Tx Power Adjustment;
  data from any Logical Channel, except data from UL-CCCH;
  MAC CE for Recommended bit rate query;
  MAC CE for BSR included for padding;
  MAC CE for SL-BSR included for padding.
NOTE 2:
Prioritization among MAC CEs of same priority is up to UE implementation.
```

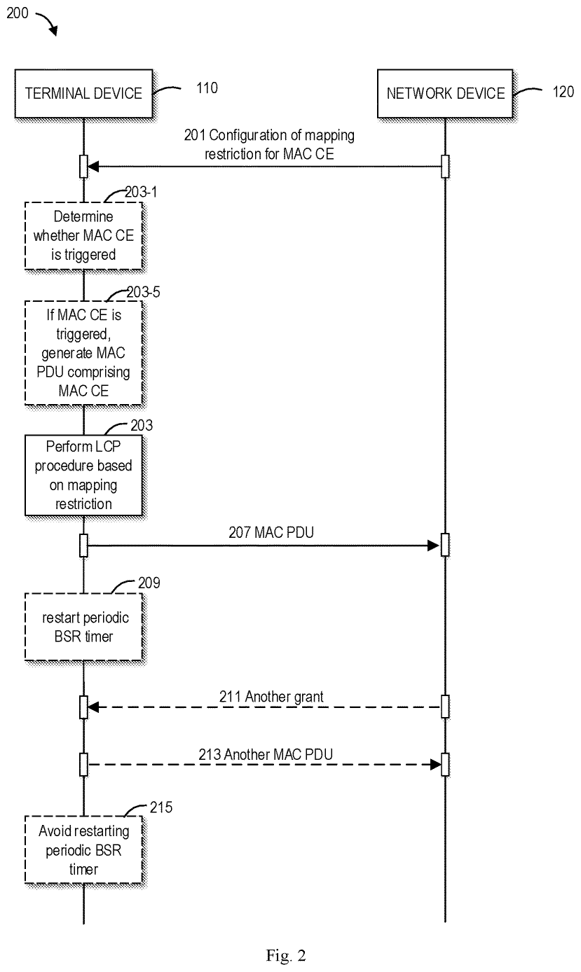

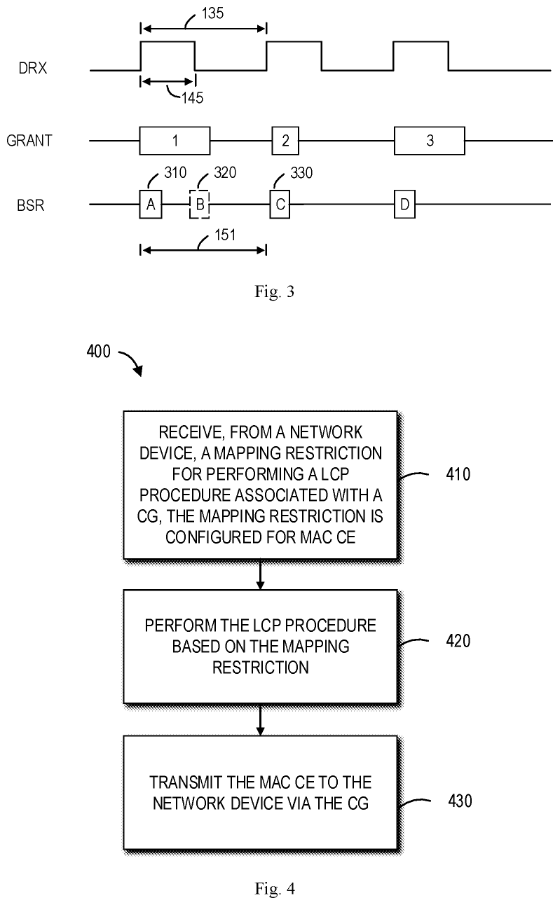

In this disclosure, a mapping restriction or LCP restriction for MAC CE, specifically for MAC CE specific for the BSR, is proposed, and the embodiments are further discussed with reference to FIGS. 2 and 3.

FIG. 2 illustrates an example signaling process 200 for applying the LCP restriction on the MAC CE for BSR according to some embodiments of the present disclosure. For the purpose of discussion, the process 200 will be described with reference to FIG. 1. The process 200 may involve the terminal device 110, 120 and the network devices 130 as illustrated in FIG. 1. It would be appreciated that although the process 200 has been described in the communication environment 100 of FIG. 1, this process 200 may be likewise applied to other communication scenarios. For illustrative purposes, the following embodiments are discussed with reference to the terminal device 120 and the network device 110 without any limitation.

In the signaling 200, the terminal device 120 (or terminal device 130) receives (201) a configuration of mapping restriction for performing a LCP procedure associated with a CG from the network device 110. The mapping restriction is configured for a MAC CE. Then, based on the mapping restriction, the terminal device 110 performs (203) the LCP procedure to generate a MAC PDU for the CG. In some embodiments, the terminal device 110 may determine (203-1) whether a MAC CE is triggered. If the MAC CE is triggered, the terminal device may generate (203-5) the MAC PDU comprising the MAC CE that is triggered. In turn, the terminal device 110 may perform the LCP procedure based on the mapping restriction configured for the MAC CE. Alternatively, if the MAC CE is not triggered, the terminal device 110 may also only perform the LCP procedure on the logic channels or the MAC PDU without MAC CE. The protection scope regarding the LCP procedure is not limited in this respect.

In some embodiments, if the data of traffic is arrived or buffered, the MAC CE specified for the BSR may be triggered. Alternatively, in some embodiments, if there is no data of traffic arrived, the MAC CE specified for the BSR may be not triggered. In addition, the MAC CE may be any MAC CE triggered on demand. In some embodiments, the MAC CE may comprise at least one of: the MAC CE specified for the BSR, the MAC CE specified for Beam Failure Resume (BFR), the MAC CE specified for Timing Advance Report, the MAC CE for Recommended bit rate query, and so on. Only for discussion clarity and without any limitation, some embodiments in this disclosure are discussed with reference to the MAC CE specified for the BSR. It is to be understood that the embodiments may be also applied to any other MAC CEs, and the protection scope regarding this aspect is not limited.

In this way, based on the configuration of mapping restriction, the MAC CE is able to be mapped to or multiplexed into the CG associated with the mapping restriction, even if the alignment between the DRX cycle (or a CG periodicity) and the periodicity of the data of traffic is affected for some reasons. In some embodiments, the MAC CE may comprise the MAC CE specified for a BSR. As such, as mentioned above, based on determining that there is arrived or buffered data available for transmission, the terminal device 110 may perform the LCP procedure for the CG by, for example, multiplexing the MAC CE specified for the BSR into the CG. In some embodiments, for each occasion of CGs configured with the configuration of mapping restriction, the terminal device 110 may trigger the MAC CE specified for the BSR. For example, a BSR can be triggered for each CG occasion configured for BSR when there is data available for transmission in the buffer.

In turn, the network device 110 may configure the periodicity of CG to be aligned with a periodic of traffic of the terminal device 120. For example, the network device 110 may configure the periodicity of CG to be aligned with the periodicity of the data traffic burst. The network device 110 may obtain the periodicity or burst arrival time of the data traffic from the Core Network (CN), for example, 5G CN, via a Next Generation Application Protocol (NGAP) signaling. Alternatively, the network device 110 may obtain the periodicity or burst arrival time of the data traffic from UE assistance information. As such, the network device 110 may configure the CG properly to align the periodicity and time offset of the CG to the traffic. In addition, new parameters or values can be introduced for indicating CG periodicity, and then the periodic BSR timer is allowed to have a better alignment with the traffic periodicity. In this way, the periodicity of the periodic BSR is also aligned with the periodicity of the CG. In this disclosure, the alignment refers that not only the periodicities are equal but also the phases or offsets are synchronized.

Then, the terminal device 110 transmits (207) the MAC CE to the network device 120 via the above CG. In this way, the MAC CE for the BSR is ensured that can be transmitted in the CG associated with the configuration of mapping restriction regardless of the status of the periodic BSR timer. Thereby, as mentioned above, the periodicity of the CG associated with configuration of mapping restriction may be configured by the network device 110 based on the traffic characteristics, such that the terminal device 120 may transmit the MAC CE for the BSR every time when a periodic data is arrived.

In some embodiments, the MAC CE may comprise the MAC CE specified for a BSR. Furthermore, the BSR may be a periodic BSR as mentioned above, and the configuration of mapping restriction may include an indication of whether the CG is used for the periodic BSR. As such, if the indication is indicative of the CG being used for the periodic BSR, and the terminal device 120 may therefore avoid using the CG for at least one of a logic channel or another MAC CE to perform the LCP procedure. Alternatively, the CG may be configured for at least one of MAC CE and a traffic (for example, pose/control traffic), and the terminal device 110 may pre-empt this CG to transmit the MAC CE. In turn, at the network device 120 side, if only receiving the MAC CE on this CG, the network device 120 may be aware that the data for the traffic is blocked to be transmitted in this CG. For example, the network device 120 may realize that the BSR pre-empts the resources that should belong to certain pose/control traffic. Then, the network device 120 may transmit an indication of an uplink resource configured for the traffic via a dynamic grant. Alternatively, the network device 120 may also configure no further uplink resource for the traffic.

In some embodiments, the terminal device 110 may also maintain a plurality of periodic BSR timers and each of the plurality of periodic BSR times is used for a respective logic channel. For example, the terminal device 110 may maintain a periodic BSR timer per logic channel, and the periodicity of the periodic BSR timer is aligned with a periodicity of traffic in the respective logic channel. Correspondingly, the network device may configure multiple CG configurations of which each CG configuration is configured with a periodicity being aligned with certain data traffic. In this way, the network device may get BSR for each data traffic when there are multiple data traffics with different periodicities.

In some embodiments, the periodic BSR timer is restarted only if the terminal device 110 transmits the MAC CE in the CG associated with the configuration of mapping restriction. In this case, with the CG configured with the configuration of mapping restriction, the terminal device may transmit the MAC CE for the BSR timely and precisely. For example, upon the terminal device transmits the MAC CE at step 205, the terminal device 110 may restart (209) the periodic BSR timer. In addition, if the terminal device 120 transmits a MAC CE on a CG (for example, the CG without the configuration of mapping restriction) other than the CG associated with the configuration of mapping restriction, the terminal device 120 may avoid restarting a periodic BSR timer. In some embodiments, the terminal device 120 may receive (211) another grant from the network device 110. For example, the other grant may comprise another CG or another dynamic grant. In some other embodiments, this grant may be any other grant for uplink resources. Moreover, there is available resource space for incorporating a Regular BSR or Padding BSR. Then, terminal device 110 may transmit (213) another MAC CE specific for the BSR via this grant. In turn, since the grant is not configured with the configuration of mapping restriction, the terminal device 110 may avoid (215) restarting the periodic BSR timer. Only for illustrative purposes, the restart of the periodic BSR timer is further discussed with reference to FIG. 3.

FIG. 3 illustrates an example of the BSR report by applying a configuration of mapping restriction for CG according to some embodiments of the present disclosure. As shown in FIG. 3, the terminal device 110 may transmit the MAC CE A 310 specific to the BSR via the CG associated with the configuration of mapping restriction. Correspondingly, the periodic BSR timer is restarted. Then, the terminal device 120 transmits the MAC CE B 320 specific to the BSR via a grant, and BSR in the MAC CE B is not a truncated BSR. However, since the grant is not configured with the configuration of mapping restriction, the terminal device 110 avoids the restart of the periodic BSR timer. In turn, the terminal device 110 may transmit the MAC CE 330 specified to the BSR when the periodic BSR timer which restarted by 310 expires.

Alternatively, the above embodiments may be also expressed below.

ConfiguredGrantConfig
The IE ConfiguredGrantConfig is used to configure uplink transmission without
dynamic grant according to two possible schemes. The actual uplink grant
may either be configured via RRC (type1) or provided via the PDCCH
(addressed to CS-RNTI) (type2). Multiple Configured Grant configurations
may be configured in one BWP of a serving cell.
ConfiguredGrantConfig information element

-- ASN1START
-- TAG-CONFIGUREDGRANTCONFIG-START

| | |
|---|---|
| ConfiguredGrantConfig ::= | SEQUENCE { |

| | |
|---|---|
| frequencyHopping | ENUMERATED {intraSlot, interSlot} |

OPTIONAL, -- Need S

| | |
|---|---|
| cg-DMRS-Configuration | DMRS-UplinkConfig, |

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |

| | |
|---|---|
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |

| | |
|---|---|
| repK-RV | ENUMERATED {s1-0231, s2-0303, s3-0000} |

OPTIONAL, -- Need R

| | |
|---|---|
| periodicity | ENUMERATED { |

sym2, sym7, sym1x14, sym2x14, sym4x14,

sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | | |
|---|---|---|
| configuredGrantTimer | INTEGER | (1..64) |

OPTIONAL, -- Need R

| | |
|---|---|
| rrc-ConfiguredUplinkGrant | SEQUENCE { |

| | |
|---|---|
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |

| | | |
|---|---|---|
| dmrs-SeqInitialization | INTEGER | (0..1) |

OPTIONAL, -- Need R

| | |
|---|---|
| precodingAndNumberOfLayers | INTEGER (0..63), |

| | | |
|---|---|---|
| srs-ResourceIndicator | INTEGER | (0..15) |

OPTIONAL, -- Need R

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER |

```
(0..maxNrofPUSCH-PathlossReferenceRSs-1),
    ...,
    [[
```

| | |
|---|---|
| pusch-RepTypeIndicator-r16 | ENUMERATED {pusch-RepTypeA, pusch-RepTypeB} |

OPTIONAL, -- Need M

| | |
|---|---|
| frequencyHoppingPUSCH-RepTypeB-r16 | ENUMERATED {interRepetition, interSlot} |

OPTIONAL, -- Cond RepTypeB

| | | |
|---|---|---|
| timeReferenceSFN-r16 | ENUMERATED | {sfn512} |

```
OPTIONAL -- Need S
    ]],
    [[
```

| | |
|---|---|
| pathlossReferenceIndex2-r17 | INTEGER (0..maxNrofPUSCH-PathlossReferenceRSs-1) |

OPTIONAL, -- Need R

| | | |
|---|---|---|
| srs-ResourceIndicator2-r17 | INTEGER | (0..15) |

OPTIONAL, -- Need R

| | | |
|---|---|---|
| precodingAndNumberOfLayers2-r17 | INTEGER | (0..63) |

OPTIONAL, -- Need R

| | | |
|---|---|---|
| timeDomainAllocation-v1710 | INTEGER | (16..63) |

OPTIONAL, -- Need M

| | | |
|---|---|---|
| timeDomainOffset-r17 | INTEGER | (0..40959) |

OPTIONAL, -- Need R

| | |
|---|---|
| cg-SDT-Configuration-r17 | CG-SDT-Configuration-r17 |

| | |
|---|---|
| 5.4.5 | Buffer Status Reporting |

. . .
The MAC entity shall:

| | |
|---|---|
| 1> | if the Buffer Status reporting procedure determines that at least one BSR has been triggered and not |

cancelled:

| | |
|---|---|
| 2> | if UL-SCH resources are available for a new transmission and the UL-SCH resources can accommodate |

the BSR MAC CE plus its subheader as a result of logical channel prioritization:

| | |
|---|---|
| 3> | instruct the Multiplexing and Assembly procedure to generate the BSR MAC CE(s) as defined in clause |

6.1.3.1;

| | |
|---|---|
| 3> | if BSRAllowed is not configured for any CG: |
| 4> | start or restart periodicBSR-Timer except when all the generated BSRs are long or short Truncated or |

Extended long or short Truncated BSRs;

| | |
|---|---|
| 3> | else: |
| 4> | start or restart periodicBSR-Timer when a BSR is included in a configured UL grant with BSRAllowed |

enabled;

| | |
|---|---|
| 3> | start or restart retxBSR-Timer. |
| 2> | if a Regular BSR has been triggered and logicalChannelSR-DelayTimer is not running: |
| 3> | if there is no UL-SCH resource available for a new transmission; or |
| 3> | if the MAC entity is configured with configured uplink grant(s) and the Regular BSR was triggered for a |

logical channel for which logicalChannelSR-Mask is set to false; or

| | |
|---|---|
| 3> | if the UL-SCH resources available for a new transmission do not meet the LCP mapping restrictions (see |

clause 5.4.3.1) configured for the logical channel that triggered the BSR:

| | |
|---|---|
| 4> | trigger a Scheduling Request. |
| 5.4.3 | Multiplexing and assembly |
| 5.4.3.1 | Logical Channel Prioritization |
| 5.4.3.1.1 | General |

The Logical Channel Prioritization (LCP) procedure is applied whenever a new transmission is performed.
RRC controls the scheduling of uplink data by signalling for each logical channel per MAC entity:

priority where an increasing priority value indicates a lower priority level;
prioritisedBitRate which sets the Prioritized Bit Rate (PBR);
bucketSizeDuration which sets the Bucket Size Duration (BSD).

RRC additionally controls the LCP procedure by configuring mapping restrictions for each logical channel and
MAC CEs:

allowedSCS-List which sets the allowed Subcarrier Spacing(s) for transmission;
maxPUSCH-Duration which sets the maximum PUSCH duration allowed for transmission;
configuredGrantType1Allowed which sets whether a configured grant Type 1 can be used for transmission;
allowedServingCells which sets the allowed cell(s) for transmission;
allowedCG-List which sets the allowed configured grant(s) for transmission;
allowedPHY-PriorityIndex which sets the allowed PHY priority index(es) of a dynamic grant for

transmission;

| | |
|---|---|
| | allowedHARQ-mode which sets the allowed uplinkHARQ-mode for transmission; |
| | BSRAllowed which indicates whether the CG is used for periodic BSR. |
| 5.4.3.1.2 | Selection of logical channels |

The MAC entity shall, when a new transmission is performed:

| | |
|---|---|
| 1> | select the logical channels and MAC CE(s) for each UL grant that satisfy all the following conditions: |
| 2> | the set of allowed Subcarrier Spacing index values in allowedSCS-List, if configured, includes the |

Subcarrier Spacing index associated to the UL grant; and

| | |
|---|---|
| 2> | maxPUSCH-Duration, if configured, is larger than or equal to the PUSCH transmission duration |

associated to the UL grant; and

| | |
|---|---|
| 2> | configuredGrantType1Allowed, if configured, is set to true in case the UL grant is a Configured Grant |

Type 1; and

| | |
|---|---|
| 2> | allowedServingCells, if configured, includes the Cell information associated to the UL grant. Does not |

apply to logical channels associated with a DRB configured with PDCP duplication within the same MAC
entity (i.e. CA duplication) when CA duplication is deactivated for this DRB in this MAC entity; and

| | |
|---|---|
| 2> | allowedCG-List, if configured, includes the configured grant index associated to the UL grant; and |
| 2> | allowedPHY-PriorityIndex, if configured, includes the priority index (as specified in clause 9 of TS 38.213 |

[6]) associated to the dynamic UL grant; and

| | |
|---|---|
| 2> | allowedHARQ-mode, if configured, includes the uplinkHARQ-mode for the HARQ process associated to |

the UL grant.

| | |
|---|---|
| 2> | BSRAllowed, if configured, indicates whether the CG is used for periodic BSR. |

As mentioned above, the MAC CE can be ensured that being transmitted in the CG with the configuration of mapping restriction, and the periodicity of CG can be flexibly configured for receiving the MAC CE for BSR timely.

FIG. 4 shows a flowchart of an example method 400 implemented at a terminal device (for example, the terminal device 110) in accordance with some embodiments of the present disclosure. For the purpose of discussion, the method 400 will be described from the perspective of the terminal device 110 with reference to FIG. 1.

At 410, the terminal device 110 receives, from a network device, a configuration of mapping restriction for performing a logical channel prioritization (LCP) procedure associated with a configured grant (CG). The mapping restriction is configured for a medium access control (MAC) control element (CE). At 420, the terminal device 110 performs the LCP procedure to generate a MAC PDU for the CG based on the mapping restriction. At 430, the terminal device 110 transmits the MAC PDU to the network device via the CG.

In some embodiments, performing the LCP procedure comprises: determining whether the MAC CE is triggered; and generating, based on determining that the MAC CE is triggered, the MAC PDU comprising the MAC CE.

In some embodiments, the MAC CE comprises the MAC CE specified for a Buffer Status Report (BSR). In some embodiments, the BSR is a periodic BSR; and the configuration of mapping restriction comprises an indication of whether the CG is used for the periodic BSR.

In some embodiments, the method 400 further comprises: based on determining that the configuration of mapping restriction comprises an indication that the CG is used for the periodic BSR, the terminal device 110 may avoid using the CG for at least one of a logic channel or another MAC CE.

In some embodiments, at least one of: a periodicity of the periodic BSR is aligned with a periodicity of the CG; or a periodicity of the CG is aligned with a periodicity of a traffic of the terminal device.

In some embodiments, the method 400 further comprises: transmitting another BSR to the network device via a grant without the configuration of mapping restriction; and avoiding restarting a periodic BSR timer for transmitting a periodic BSR.

In some embodiments, receiving the configuration of mapping restriction comprises: receiving a LCP restriction configuration comprising the configuration of mapping restriction.

In some embodiments, the method 400 further comprises: maintaining a periodic BSR timer per logic channel, the periodicity of the periodic BSR timer being aligned with a periodicity of a traffic in the respective logic channel.

In some embodiments, the CG is configured for at least one of BSR and a traffic, and the method 400 further comprises: receiving an indication of an uplink resource configured for the traffic via a dynamic grant.

In some embodiments, determining whether the MAC CE is triggered comprises: based on determining that there is data in a buffer of the terminal device available for transmission, triggering the MAC CE specified for a BSR for each occasion of CGs configured with the configuration of mapping restriction.

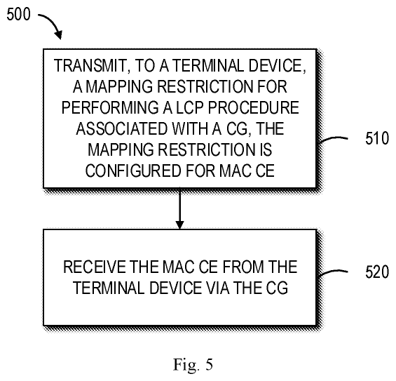

FIG. 5 shows a flowchart of an example method 500 implemented at a network device (for example, the network device 120) in accordance with some embodiments of the present disclosure. For the purpose of discussion, the method 500 will be described from the perspective of the network device 120 with reference to FIG. 1.

At 510, the network device 120 transmits, to a terminal device, a configuration of mapping restriction for performing a logical channel prioritization (LCP) procedure associated with a configured grant (CG). The mapping restriction is configured for a medium access control (MAC) control element (CE). At 520, the network device 120 receives a MAC PDU from the terminal device via the CG.

In some embodiments, the MAC CE comprises the MAC CE specified for a Buffer Status Report (BSR). In some embodiments, the configuration of mapping restriction comprises an indication of whether the CG is used for a periodic BSR.

In some embodiments, the method 500 further comprises: avoid configuring the CG for at least one of a logic channel or another MAC CE. In some embodiments, the method 500 further comprises: configuring a periodicity of the CG to be aligned with a periodicity of a traffic of the terminal device. In some embodiments, the method 500 further comprises: receiving another BSR from the terminal device via grant without the configuration of mapping restriction.

In some embodiments, transmitting the configuration of mapping restriction comprises: transmitting a LCP restriction configuration comprising the configuration of mapping restriction.

In some embodiments, the CG is configured for at least one of BSR and a traffic, and the method 500 further comprises: transmitting an indication of an uplink resource configured for the traffic via a dynamic grant.

In some embodiments, an apparatus capable of performing any of operations of the method 400 (for example, the terminal device 110) may include means for performing the respective steps of the method 400. The means may be implemented in any suitable form. For example, the means may be implemented in a circuitry or software module.

In some embodiments, the apparatus may include means for receiving, from a network device, a configuration of mapping restriction for performing a logical channel prioritization (LCP) procedure associated with a configured grant (CG). The mapping restriction is configured for a medium access control (MAC) control element (CE). The apparatus further may include means for performing the LCP procedure to generate a MAC PDU for the CG based on the mapping restriction; and means for transmitting the MAC PDU to the network device via the CG.

In some embodiments, the means for performing the LCP procedure comprises: means for determining whether the MAC CE is triggered; and means for generating, based on determining that the MAC CE is triggered, the MAC PDU comprising the MAC CE.

In some embodiments, the MAC CE comprises the MAC CE specified for a Buffer Status Report (BSR). In some embodiments, the BSR is a periodic BSR; and the configuration of mapping restriction comprises an indication of whether the CG is used for the periodic BSR.

In some embodiments, the means for performing the LCP procedure may include means for based on determining that the configuration of mapping restriction comprises an indication that the CG is used for the periodic BSR, avoiding using the CG for at least one of a logic channel or another MAC CE.

In some embodiments, at least one of: a periodicity of the periodic BSR is aligned with a periodicity of the CG; or a periodicity of the CG is aligned with a periodicity of a traffic of the terminal device.

In some embodiments, the apparatus may further include means for transmitting another BSR to the network device via a grant without the configuration of mapping restriction; and means for avoiding restarting a periodic BSR timer for transmitting a periodic BSR.

In some embodiments, the means for receiving the configuration of mapping restriction may include means for receiving a LCP restriction configuration comprising the configuration of mapping restriction.

In some embodiments, the apparatus may further include means for maintaining a periodic BSR timer per logic channel. The periodicity of the periodic BSR timer is aligned with a periodicity of a traffic in the respective logic channel.

In some embodiments, the CG is configured for at least one of BSR and a traffic, and the apparatus may further include means for receiving an indication of an uplink resource configured for the traffic via a dynamic grant.

In some embodiments, the means for determining whether the MAC CE is triggered may include means for based on determining that there is data in a buffer of the terminal device available for transmission, triggering the MAC CE specified for a BSR for each occasion of CGs configured with the configuration of mapping restriction.

In some embodiments, the apparatus further comprises means for performing other steps in some embodiments of the method 400. In some embodiments, the means comprises at least one processor and at least one memory including computer program code, the at least one memory and computer program code configured to, with the at least one processor, cause the performance of the apparatus.

In some embodiments, an apparatus capable of performing any of the method 500 (for example, the network device 120) may include means for performing the respective steps of the method 500. The means may be implemented in any suitable form. For example, the means may be implemented in a circuitry or software module.

In some embodiments, the apparatus may further include means for transmitting, to a terminal device, a configuration of mapping restriction for performing a logical channel prioritization (LCP) procedure associated with a configured grant (CG). The mapping restriction is configured for a medium access control (MAC) control element (CE). The apparatus may further include means for means for receiving a MAC PDU from the terminal device via the CG.

In some embodiments, the MAC CE comprises the MAC CE specified for a Buffer Status Report (BSR). In some embodiments, the configuration of mapping restriction comprises an indication of whether the CG is used for a periodic BSR.

In some embodiments, the apparatus may further include means for avoiding configuring the CG for at least one of a logic channel or another MAC CE. In some embodiments, the apparatus may further include means for configuring a periodicity of the CG to be aligned with a periodicity of a traffic of the terminal device. In some embodiments, the apparatus may further include means for receiving another BSR from the terminal device via grant without the configuration of mapping restriction.

In some embodiments, the means for transmitting the configuration of mapping restriction may include means for transmitting a LCP restriction configuration comprising the configuration of mapping restriction.

In some embodiments, the CG is configured for at least one of BSR and a traffic, and the apparatus may further include means for transmitting an indication of an uplink resource configured for the traffic via a dynamic grant.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

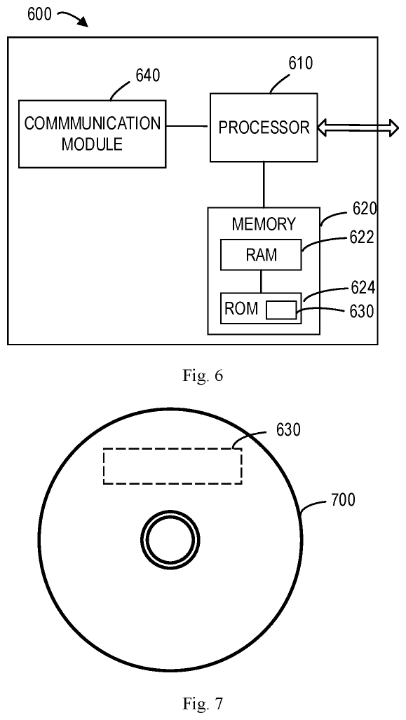

FIG. 6 is a simplified block diagram of a device 600 that is suitable for implementing embodiments of the present disclosure. The device 600 may be provided to implement the communication device, for example the terminal device 110 as shown in FIG. 1. As shown, the device 600 includes one or more processors 610, one or more memories 640 coupled to the processor 610, and one or more transmitters and/or receivers (TX/RX) 640 coupled to the processor 610.

The TX/RX 640 is for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a read only memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program so that the device 600 may perform any process of the disclosure as discussed with reference to FIGS. 2 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out process 200, the method 400 or 500 as described above with reference to FIG. 2 to FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-24. (canceled)

25. A terminal device comprising:
at least one processor; and
at least one memory storing instructions that, when executed by the at least one processor, cause the terminal device to:
receive, from a network device, a configuration of mapping restriction for performing a logical channel prioritization (LCP) procedure associated with a configured grant (CG), the mapping restriction being configured for a medium access control (MAC) control element (CE);
based on determining that there is data in a buffer of the terminal device available for transmission, triggering the MAC CE specified for a BSR for each occasion of CGs configured with the configuration of mapping restriction;
perform the LCP procedure generate, based on determining that the MAC CE is triggered, a MAC Protocol Data Unit (PDU) comprising the MAC CE for the CG based on the mapping restriction, wherein the MAC CE comprises the MAC CE specified for a Buffer Status Report (BSR), wherein the BSR is a periodic BSR, and wherein the configuration of mapping restriction comprises an indication of whether the CG is used for the periodic BSR, wherein a periodicity of the periodic BSR is aligned with a periodicity of the CG and the periodicity of the CG is aligned with a periodicity of a traffic of the terminal device;
based on determining that the configuration of mapping restriction comprises an indication that the CG is used for the periodic BSR, avoid using the CG for at least one of a logic channel or another MAC CE; and
transmit the MAC PDU to the network device via the CG.

26. The terminal device of claim 25, wherein the terminal device is further caused to:
transmit another BSR to the network device via a grant without the configuration of mapping restriction; and
avoid restarting a periodic BSR timer for transmitting a periodic BSR.

27. The terminal device of claim 26, wherein the terminal device is caused to receive the configuration of mapping restriction by:
receiving a LCP restriction configuration comprising the configuration of mapping restriction.

28. The terminal device of claim 27, wherein the terminal device is further caused to:
maintain a periodic BSR timer per logic channel, a periodicity of the periodic BSR timer being aligned with a periodicity of a traffic in a respective logic channel.

29. The terminal device of claim 28, wherein the CG is configured for at least one of BSR and a logic channel, and wherein the terminal device is further caused to:
receive an indication of an uplink resource configured for the logic channel via a dynamic grant.

30. A system comprising:
a terminal device;
at least one processor; and
at least one memory storing instructions that, when executed by the at least one processor, cause the terminal device to:
receive, from a network device, a configuration of mapping restriction for performing a logical channel prioritization (LCP) procedure associated with a configured grant (CG), the mapping restriction being configured for a medium access control (MAC) control element (CE);
based on determining that there is data in a buffer of the terminal device available for transmission, triggering the MAC CE specified for a BSR for each occasion of CGs configured with the configuration of mapping restriction;
perform the LCP procedure generate, based on determining that the MAC CE is triggered, a MAC Protocol Data Unit (PDU) comprising the MAC CE for the CG based on the mapping restriction, wherein the MAC CE comprises the MAC CE specified for a Buffer Status Report (BSR), wherein the BSR is a periodic BSR, and wherein the configuration of mapping restriction comprises an indication of whether the CG is used for the periodic BSR, wherein a periodicity of the periodic BSR is aligned with a periodicity of the CG and the periodicity of the CG is aligned with a periodicity of a traffic of the terminal device;
based on determining that the configuration of mapping restriction comprises an indication that the CG is used for the periodic BSR, avoid using the CG for at least one of a logic channel or another MAC CE; and
transmit the MAC PDU to the network device via the CG.

31. The system of claim 30, wherein the terminal device is further caused to:
transmit another BSR to the network device via a grant without the configuration of mapping restriction; and
avoid restarting a periodic BSR timer for transmitting a periodic BSR.

32. The system of claim 31, wherein the terminal device is caused to receive the configuration of mapping restriction by:
receiving a LCP restriction configuration comprising the configuration of mapping restriction.

33. The system of claim 32, wherein the terminal device is further caused to:
maintain a periodic BSR timer per logic channel, a periodicity of the periodic BSR timer being aligned with a periodicity of a traffic in a respective logic channel.

34. The system of claim 33, wherein the CG is configured for at least one of BSR and a logic channel, and wherein the terminal device is further caused to:
receive an indication of an uplink resource configured for the logic channel via a dynamic grant.

35. A method comprising:
receiving, by a terminal device from a network device, a configuration of mapping restriction for performing a logical channel prioritization (LCP) procedure associated with a configured grant (CG), the mapping restriction being configured for a medium access control (MAC) control element (CE);
based on determining that there is data in a buffer of the terminal device available for transmission, triggering, by the terminal device, the MAC CE specified for a BSR for each occasion of CGs configured with the configuration of mapping restriction;
performing the LCP procedure generate, based on determining that the MAC CE is triggered, a MAC Protocol Data Unit (PDU) comprising the MAC CE for the CG based on the mapping restriction, wherein the MAC CE comprises the MAC CE specified for a Buffer Status Report (BSR), wherein the BSR is a periodic BSR, and wherein the configuration of mapping restriction comprises an indication of whether the CG is used for the periodic BSR, wherein a periodicity of the periodic BSR is aligned with a periodicity of the CG and the periodicity of the CG is aligned with a periodicity of a traffic of the terminal device;
based on determining that the configuration of mapping restriction comprises an indication that the CG is used for the periodic BSR, avoiding, by the terminal device, using the CG for at least one of a logic channel or another MAC CE; and
transmitting, by the terminal device, the MAC PDU to the network device via the CG.

36. The method of claim 35, further comprising:
transmitting another BSR to the network device via a grant without the configuration of mapping restriction; and
avoiding restarting a periodic BSR timer for transmitting a periodic BSR.

37. The method of claim 36, further comprising:
receiving, by the terminal device, the configuration of mapping restriction by receiving a LCP restriction configuration comprising the configuration of mapping restriction.

38. The method of claim 37, further comprising:
maintaining a periodic BSR timer per logic channel, a periodicity of the periodic BSR timer being aligned with a periodicity of a traffic in a respective logic channel.

39. The method of claim 38, wherein the CG is configured for at least one of BSR and a logic channel, and wherein the terminal device is further caused to:
receive an indication of an uplink resource configured for the logic channel via a dynamic grant.
